(19) United States
(12) Patent Application Publication
(10) Pub. No.: US 2011/0276503 A1
(43) Pub. Date: Nov. 10, 2011

(54) METHODS, SYSTEMS, AND COMPUTER READABLE MEDIA FOR PROVIDING WEB APPLICATION-BASED GOVERNMENT GRANT COMPLIANCE MONITORING, DATA MINING, AND AUTOMATIC RESUME GENERATION

(76) Inventor: Dawayne Whittington, Durham, NC (US)

(21) Appl. No.: 13/102,999

(22) Filed: May 6, 2011

Related U.S. Application Data
(60) Provisional application No. 61/332,464, filed on May 7, 2010.

(51) Int. Cl. G06Q 99/00; G06Q 10/00

(52) U.S. Cl. 705/317; 705/320

(57) ABSTRACT

Methods, systems, and computer readable media for providing web application-based government and institutional grant compliance monitoring, data mining, reporting, automatic resume generation, and automatic group and individual comparisons of progress are disclosed. According to one method, information is received from a user relating to their career via a web-based application. At least a subset of the information is automatically formatted and provided to a third-party for grant compliance monitoring. At least a subset of the information is automatically formatted and provided to the user as a resume.

### PRIORITY CLAIM

This application claims the benefit of U.S. Provisional Patent Application Ser. No. 61/332,464 filed May 7, 2010; the disclosure of which is incorporated herein by reference in its entirety.

### TECHNICAL FIELD

The subject matter described herein relates to government grant compliance monitoring. More specifically, the subject matter relates to methods, systems, and computer readable media for providing web application-based government grant and institutional compliance monitoring, data mining, reporting, automatic resume generation, and automatic group and individual comparisons of progress.

### BACKGROUND

Over the last decade, the National Institutes of Health (NIH) has funded, on average, about 15,000 biomedical science trainees per year at various stages in their careers, with 2009 financial data showing a total of $790 million spent on research training. Data from the National Science Foundation's (NSF) financial report for fiscal year 2009 show that this agency spent roughly $860 million on education and training across more than 90,000 trainees, ranging from undergraduates through postdoctoral scholars. Together, this represents a federal investment of over $1.6 billion in 2009. In addition, data from a May 20, 2010 press release from Howard Hughes Medical Institute (HHMI) announced an investment of $79 million more for its Precollege and Undergraduate Science Education Program, adding to the $101 million they put toward training grants and special programs in 2009. These data point to the significant amount of resources annually invested in training tomorrow's scientists. However, science education researchers have faced numerous difficulties examining the effectiveness and outcomes of these training programs because there is currently no systematic way of collecting and housing data about the program participants. In other words, current methods and systems fail to provide a comprehensive electronic tracking tool for performing government grant compliance monitoring of these training programs.

For example, a 2005 report by the National Academies of Science, titled Assessment of NIH Minority Research and Training Programs: Phase 3 describes challenge to analyzing data maintained within individual programs and how the lack of a centralized, systematic way of tracking participants posed major challenges in evaluating the effectiveness of minority research training programs. The report explains that it proved difficult to locate and interview trainees and, as a result, the response rate was very low. Another challenge to analyzing data maintained within individual programs is that the data systems used by individual projects may be uncoordinated and inadequate for performing government grant compliance monitoring. For example, data sets may be distributed across the various institutes and centers at NIH in a variety of formats (i.e., annual progress reports, grant supplements, and in-house Excel spreadsheets), and these data may not be stored centrally or electronically. In addition, the data may not use common definitions or include different forms of information. Because the level of granularity offered by conventional systems is limited, the data sets are often inadequate for identifying, for example, minority trainees who participated in targeted programs because no data element contained within these data sets consistently identifies minority participants.

Accordingly, in light of these difficulties, a need exists for improved methods, systems, and computer readable media for a data collection system for trainee tracking to assess program efficacy on an ongoing basis that is cost effective and that engages trainees directly.

### SUMMARY

Methods, systems, and computer readable media for providing web application-based government grant compliance monitoring, data mining, automatic resume generation, automatic statistical summaries and comparison reports are disclosed. According to one method, information is received from a user relating to their career progress via a web-based application interface. At least a subset of the information is automatically formatted and provided to a third-party for grant compliance monitoring. At least a subset of the information is automatically formatted and provided to the user as a resume. At least a subset of this information is used to provide career profile comparisons summaries to the user and a third party.

A system for providing web application-based government grant compliance monitoring, data mining, automatic statistical summaries and comparison reports, and automatic resume generation is also disclosed. The system includes a communications module that receives information from a user relating to their career via a web-based application interface. A grant compliance monitoring module automatically formats and provides at least a subset of the information to a third-party for grant compliance monitoring. A resume building module automatically formats and provides at least a subset of the information to the user as a resume.

The subject matter described herein for providing web application-based government grant compliance monitoring, data mining, automatic statistical summaries and comparison reports, and automatic resume generation may be implemented using a non-transitory computer readable medium to having stored thereon executable instructions that when executed by the processor of a computer control the processor to perform steps. Exemplary non-transitory computer readable media suitable for implementing the subject matter described herein include chip memory devices or disk memory devices accessible by a processor, programmable logic devices, and application specific integrated circuits. In addition, a computer readable medium that implements the subject matter described herein may be located on a single computing platform or may be distributed across plural computing platforms.

### BRIEF DESCRIPTION OF THE DRAWINGS

The subject matter described herein will now be explained with reference to the accompanying drawings of which:

FIG. 1 is a screenshot illustrating an exemplary web-based, graphical user interface for user entry for providing web application-based government grant compliance monitoring, data mining, and automatic resume generation according to an embodiment of the subject matter described herein;

FIG. 2 is a screenshot illustrating an exemplary web-based, graphical user interface of a “standard” biosketch for providing web application-based government grant compliance monitoring, data mining, and automatic resume generation according to an embodiment of the subject matter described herein;

FIG. 3 is a screenshot illustrating an exemplary “Project Leaders' Rates of Progress Report” for providing web application-based government grant compliance monitoring, data mining, and automatic resume generation according to an embodiment of the subject matter described herein;

FIG. 4 is a screenshot illustrating an exemplary “Project Leaders'Statistics Per Trainee Report” for providing web application-based government grant compliance monitoring, data mining, and automatic resume generation according to an embodiment of the subject matter described herein;

FIG. 5 is a chart illustrating exemplary comparison graphs for directors for providing web application-based government grant compliance monitoring, data mining, and automatic resume generation according to an embodiment of the subject matter described herein;

FIG. 6 is a chart illustrating exemplary comparison graphs for trainees for providing web application-based government grant compliance monitoring, data mining, and automatic resume generation according to an embodiment of the subject matter described herein; and

FIG. 7 is a block diagram of an exemplary hardware system for providing web application-based government grant compliance monitoring, data mining, and automatic resume generation according to an embodiment of the subject matter described herein.

### DETAILED DESCRIPTION

The subject matter described herein includes a combination of resume builder front-end for a grant compliance monitoring back-end web application. Advantages of the subject matter described herein includes providing government grant compliance administrators a means for obtaining improved annual feedback on research training programs, assisting the development of future goals, assisting the development of performance measures, and assisting the improvement of program effectiveness. Also, by engaging trainees directly, given the financial costs of trying to locate trainees after they leave the training program and the very low probability of actually finding them, the cost of tracking trainees may be reduced and future resources may be conserved thereby rendering future assessments more feasible.

For example, in one embodiment, a password-protected, web-based application accessible at iBiosketch.com may collect career outcome data across a standard set of categories popular to most science training grants funded through government agencies and private foundations. The collection of these data along standard categories allows directors of training grants to: 1) more efficiently assess the quality of applicants to their program along consistent measures; 2) document the success of their training efforts by individual or sets of participants; 3) track the progress of participants after they exit the university/training program; and 4) efficiently create tables of outcome data that are typically required for reporting progress to stakeholders, such as university leadership and state or federal government funding agencies.

In addition to facilitating program assessment, the subject matter described herein may benefit program trainees by offering them the ability to: 1) store their progress data during and after participation in a given funded program/enrollment at an institution; 2) view summaries of their progress in relation to others at similar career levels; and 3) create customized electronic sketches of their career progress and/or resumes from as early as pre-college through their career position in academia or industry. The subject matter described herein may also automate the creation of standard resume formats for any funding agency, such as the biographical sketch format for the National Institutes of Health. These sketches can be shared through a customized uniform resource location (URL) that dynamically updates as the trainee enters future data and/or through various social media sites (e.g., Facebook, Twitter, LinkedIn).

A trainee score may be determined for predicting how well a student will likely perform or, put another way, for predicting the likelihood of that student obtaining a PhD, MD, or other suitable metric of interest to directors of training grants. There may be a separate trainee score for terminal degrees and post-terminal degrees thereby providing an indication that the student will go to “the next level” in their career (e.g., tenure, publication). In some embodiments, separate trainee scores for terminal degrees and post-terminal degrees may be used and in other embodiments, a unified trainee score may be used for both pre-terminal and post-terminal degree time periods. The score may be useful in helping trainees assess their marketability. The score may be useful in helping a third party determine the eligibility for continued studies or admissions into advanced degree programs or various career positions.

A project progress score may also be determined for grading the performance of a project leader. In other words, a project progress score may provide an indication of a project leader's ability/likelihood of getting a certain number of students to the next level (e.g., from undergraduate to graduate school, from graduate school to postdoctoral fellowship, etc.) For example, a project progress score of 80 may indicate that 80% of a group of students are likely to achieve a predetermined outcome. This may be useful to the Federal Government or other grant-compliance monitoring agencies in evaluating whether a project leader is effectively helping students to progress in their schooling or careers. The score may be useful in helping the Federal Government select grants eligible for continued funding.

As will be described in greater detail below, in one possible embodiment, the subject matter described herein may offer two different types of account logins to the iBiosketch.com website in order to accommodate the different needs of both trainees and training project leaders. Below are details on the features for each type of account that separate this Web application from the standard Excel sheets and surveys most directors use to track trainees' career progress. While only a limited number of screenshots are provided, the screenshots are not intended to be limited, and it may be appreciated that additional features or elements which are not illustrated herein may be implemented without departing from the scope of the subject matter described herein.

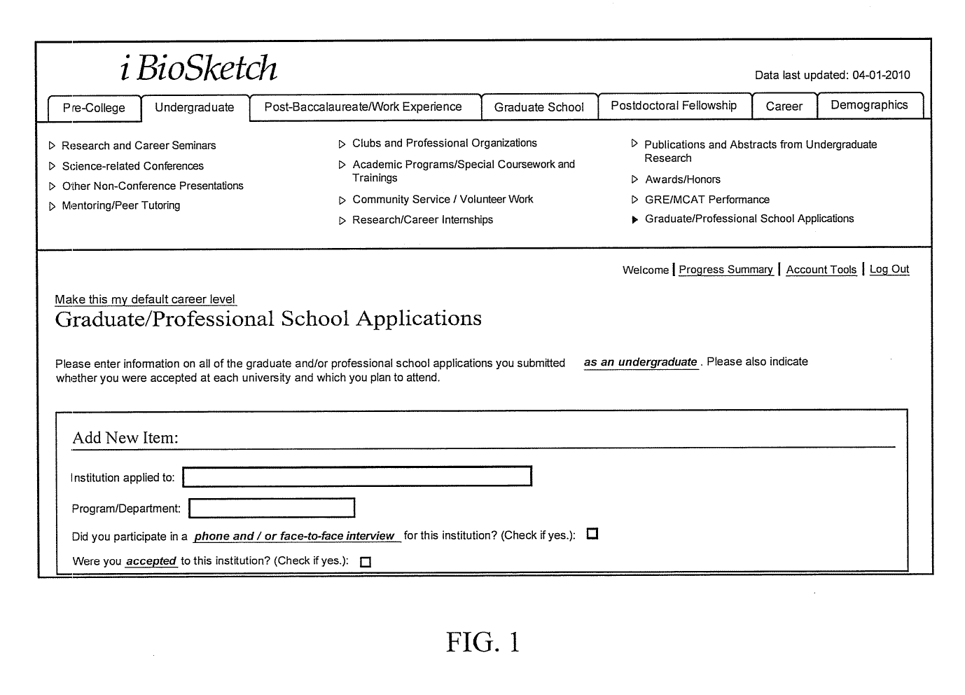

FIG. 1 is a screenshot illustrating an exemplary web-based, graphical user interface for user entry for providing web application-based government grant compliance monitoring, data mining, and automatic resume generation according to an embodiment of the subject matter described herein. For example, referring to FIG. 1, several tabs may be used to navigate between different parts of the user interface where career progress data are entered. In the embodiment shown, a user can access Pre-College, Undergraduate, Post-Baccalaureate/Work Experience, Graduate School, Postdoctoral Fellowship, Career, and Demographics information. If the user is a student or trainee, the information may include their personal information. If the user is a third party (e.g., school administrator, advertiser, etc.), the information displayed may be associated with any person the third party is authorized to view or multiple students (in either aggregated or non-aggregated formats).

Because the Undergraduate tab has been selected, undergraduate-specific information is displayed. For example, a bulleted selection of items such as Research and Career Seminars, Clubs and Professional Organizations, GRE/MCAT test performance, etc. may be listed. Continuing the example shown, it may be appreciated that Graduate/Professional School Applications has been selected as indicated by the black triangle to the left of this item. Therefore, in the window located toward the bottom half of the screenshot, a web-based form may be provided that allows the student to enter a new item relating to a graduate or professional school application. This may include the name of the institution, the program or department applied to, and so on.

### Student/Trainee Features

In one embodiment, the web-based application may be secured with username and password-protected access controls. For example, the system may require that every user register in order to create a unique username and password combination. Thereafter, the system may require that every registered user enter their username and password for access to the system.

In another embodiment, the web-based application may include an entry interface allowing for storing and editing demographic and career progress data across five different levels (pre-college, undergraduate, post-baccalaureate, graduate school, postdoctoral fellowship, and career).

In another embodiment, the web-based application may store and date-stamp all career progress data that are entered, so that a trainee never has to re-enter any data that has already been provided.

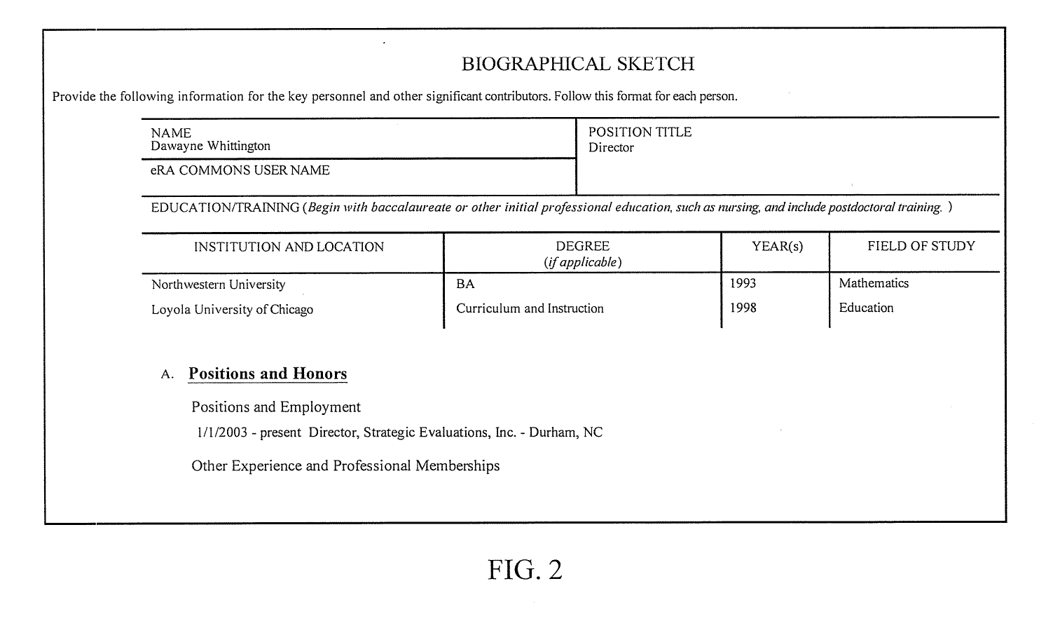

FIG. 2 is a screenshot illustrating an exemplary web-based, graphical user interface of a “standard” biosketch for providing web application-based government grant compliance monitoring, data mining, and automatic resume generation according to an embodiment of the subject matter described herein. As used herein, the term “biosketch” refers to a brief biography of a person (i.e., a biographical sketch). A biosketch may be a brief summary of a person's professional/educational accomplishments, that may include publications, affiliations, and abbreviated curriculum vitae meant to highlight important aspects of the person's training, experience, and areas of interest. Referring to the exemplary sample of a biosketch shown in FIG. 2, the biosketch may include the person's name, job title, username, and education among other things. Education may include various details such as a listing of the institutions the person attended, their locations, any degrees conferred, years of attendance, and a field of study. Similarly, the person's job titles/positions may include information similar to a resume such as a listing of employment, locations, and time periods.

In one embodiment, the subject matter described herein may include a resume-generating feature that automates the creation of a federally supported biosketch format or a self-designed biosketch in which trainees have the ability to select which categories and data appear.

In another embodiment, the subject matter described herein may include a biosketch sharing feature that allows trainees to download a biosketch or send a link to a colleague. A hyperlink to the biosketch may be dynamically updated, meaning that as the trainee adds new career progress to the Web application, the hyperlink may automatically be updated to reflect the changes.

In another embodiment, the subject matter described herein may include a biosketch sharing feature that allows trainees to transmit the data to their mobile phone/tablet computer or the mobile phone/tablet computer of a colleague. A hyperlink to the biosketch may be dynamically updated, meaning that as the trainee adds new career progress to the Web application, the hyperlink may automatically be updated to reflect the changes. Additionally, methods for users to share their biosketches may include links to popular social media sites (e.g, FaceBook, Twitter, LinkedIn) and the ability to automatically link biosketches to a blog or Wikispace. A mobile application (aka app) may be designed for various mobile smartphone platforms (e.g., Android, iOS, WM7) that will allow users to update and share their biosketches from mobile devices, including near field communications (NFC), Bluetooth, and other short range communications technologies (e.g., “bump” sharing) for exchanging biosketches with other users. This may allow users to tap or bump their handhelds together in order to transfer their biosketches between each other, which may be useful in aiding interpersonal networking at conferences and other meetings. In a similar way, project leaders can tap or bump handhelds together in order to transfer a subset of the entirety of their progress data and or statistical summaries.

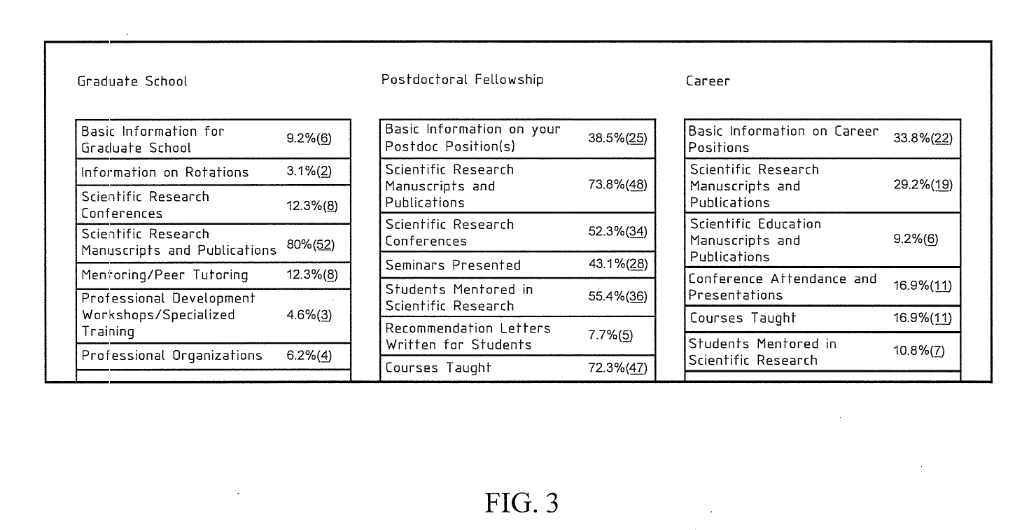

FIG. 3 is a screenshot illustrating an exemplary “Project Leaders' Rates of Progress Report” for providing web application-based government grant compliance monitoring, data mining, and automatic resume generation according to an embodiment of the subject matter described herein. This chart may be useful to administrators, project leaders, or other third parties to determine how many monitored users (and the corresponding percentages) have completed each metric of interest. Referring to FIG. 3, the screenshot may be divided into three columns where each column is associated with a different type of information. For example, six users (corresponding to 9.2% of total users) have entered basic information for graduate school while four users (6.2%) have entered information associated with participation in professional organizations. Similarly, a breakdown of user progress is provided for categories/metrics related to Postdoctoral Fellowships and Careers. This may allow a project leader to see, at a glance, the career areas in which progress is high or low.

In another embodiment, the subject matter described herein may provide reports on trainees' login status and data on individuals' compliance to enter progress data. For example, this may include a report that lists all trainees that were ever selected to be part of the grant. As shown in FIG. 3, the screen may display their cohort, active status, and the last date on which the trainee logged in to review or edit his or her profile.

According to another embodiment, the subject matter described herein may provide a Summary of Demographics report. This may include a summary of the demographics of all trainees that have been part of the grant.

According to another embodiment, the subject matter described herein may provide Pre-Designed Reports of Trainees' Progress report. This may include several pre-designed reports for directors to review trainees' progress and/or demographics. Any reports can be modified to show only the students who are active in the program, ignoring inactive or prior students.

According to another embodiment, the subject matter described herein may provide Detailed Progress Reports to allow leaders to display the progress for a specific category. For example, a director could use this report to display all of the graduate school applications their undergraduate trainees completed or all of the publications their post-docs submitted after they started their careers.

According to another embodiment, the subject matter described herein may provide Rates of Progress Reports to enable leaders to see quantitative data summaries for their trainees/program. The report may display the number and percentage of trainees reporting progress in a specific area. It could answer such questions as, “How many and what percent of my graduate students have published a paper while participating in my project?” Because the tool tracks trainees beyond their participation in a given program, the director could also answer questions that begin to shed light on the impact the training had on future progress, such as “What percent of my graduate students have submitted grants as postdocs?”

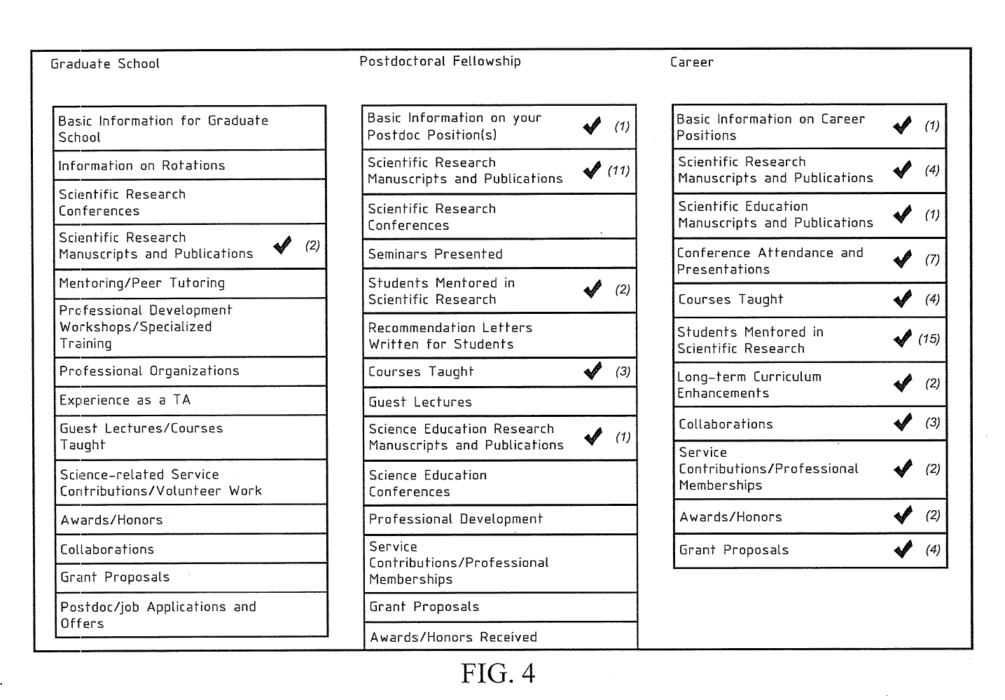

FIG. 4 is a screenshot illustrating an exemplary “Project Leaders' Statistics Per Trainee Report” for providing web application-based government grant compliance monitoring, data mining, and automatic resume generation according to an embodiment of the subject matter described herein. In comparison to FIG. 3, FIG. 4 shows individual statistics in the various categories (e.g., graduate school, postdoctoral fellowship, and career) rather than an aggregated measure of multiple users. Here, a “check” mark may indicate that the individual user has completed at least one item in a particular category. For example, the user has completed and entered information regarding two scientific research manuscripts in graduate school but has not entered any experience he or she may have had as a teaching assistant (TA) which is indicated by a check mark next to the Scientific Research Manuscripts and Publications section and no check mark next to the Experience as a TA section.

According to one embodiment, the subject matter described herein may provide Statistics per Trainee Reports to allow a project director to display all progress made across all career levels for any specific user. The report can be used to answer the question, “How many job applications and interviews did Joe Smith complete, and how many of these resulted in offers?”

According to another embodiment, the subject matter described herein may provide Customizable Reports on Trainees' Progress to give the director flexibility to display progress for a specific query. For example, in a few mouse clicks, a director can query the dataset and answer the question, “What percent of my African-American, female, graduate students have applied for post-doc fellowships?” or “Are the US Citizens who are part of my project submitting more grants than my non-US Citizens?”

According to another embodiment, the subject matter described herein may provide Downloadable Data. For example, every report described above may be downloadable to Microsoft Excel or a variety of other formats for further analysis. Each record may transfer over with the trainee's name as well as the date the record was last modified.

According to another embodiment, the subject matter described herein may provide Additional Project-Level Tracking Tools that allow a director to track a variety of items that are accessible only to project leaders. These may include data categories such as recruitment activities, collaborations, and dissemination and institutionalization efforts. Other tracking options may include data more private in nature such as ratings for applicants, coaching sessions provided to trainees, and performance ratings from mentors. These can be stored and linked to trainees without their knowledge of the process.

According to another embodiment, the subject matter described herein may provide Communication Tools that allow the director to send email reminders and/or invite new trainees to be part of the group by sending out an automatic request.

According to another embodiment, the subject matter described herein may provide Communication Tools that allow the director/trainee to select settings within their accounts to have the system send automatic email reminders and/or reports.

Although iBiosketch's design facilitates tracking and reporting of progress data for individual projects, the Web application can also be used to track and investigate the impact of entire trainee programs or several projects similar in nature. This may be accomplished through “program administrators” accounts. For example, program administrators may include scientists who would be interested in tracking career progress of trainees across several projects, e.g. NIH Program Officers, Deans of Institutions, or PIs of several training grants. As a result of the system's ability to cluster data, iBiosketch can easily transition from tracking trainees and providing data for single projects to providing reports across several. Likewise, the subject matter described herein may be capable of clustering reports across all science training programs on one campus. The questions listed in the table below provide a stronger sense of the different questions the tool helps answer for program administrators.

TABLE 1
Examples of Queries Answered by the Project Leader
Feature versus the Expanded Administrator Feature

| Reports | Project Leader Feature | Expanded Administrator Feature |
|---|---|---|
| Demographics | What percent of the trainees in | What percent of the trainees |
| | this specific project are female? | across all of the funded projects |
| | | on this campus are female? |
| Category Progress | Give me a list of all of the | Give me a list of all of the |
| | publications my trainees have | publications trainees across all |
| | submitted as graduate students. | of the projects I oversee have |
| | | submitted as graduate students. |
| Trainee/Project | How many job | How many job applications/ |
| Statistics | applications/interviews did Joe | interviews did trainees across in |
| | Smith complete, and how many | Project A complete, and how |
| | of these resulted in offers? | many of these resulted in |
| | | offers?” |
| Rates of Progress | How many and what percent of | How many and what percent of |
| | my graduate students in this | graduate students across all |
| | project have published a paper? | projects have published a |
| | | paper? |
| Filtered/Customizable | Are the US Citizens who are | Are the US Citizens across-all |
| Reports | part of my project submitting | the projects I oversee |
| | more grants than my non-US | submitting more grants than my |
| | Citizens? | non-US Citizens? |

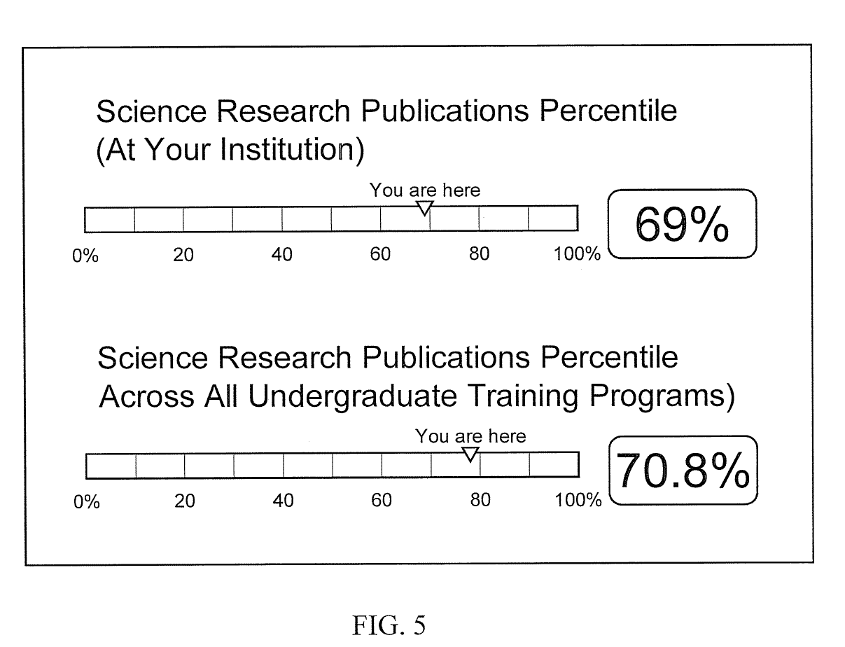

FIG. 5 is a chart illustrating exemplary comparison graphs for directors for providing web application-based government grant compliance monitoring, data mining, and automatic resume generation according to an embodiment of the subject matter described herein. This is an example of a project level comparison that allows directors to measure the performance of a particular training grant against similar grants at other institutions. For example, referring to FIG. 5, the upper chart shows how the output of science research publications currently ranks at the institution the user is currently working. The lower chart shows how the output of science research publications currently ranks, as a percentile, across all undergraduate training programs. As may be appreciated from FIG. 5, science research publication output at the individual institution-level ranks in the 69th percentile, and ranks higher, in the 70.8th percentile, when measured against all undergraduate training programs. This allows directors to see, at a glance, how a project is performing from a project-level comparison.

### Project-Level Comparisons

One of the largest deficiencies of current project-level progress reports is the lack of comparison data. This tool enhances the evaluation rigor of science training projects by providing access to aggregate data for a similar set of trainees. In order to maintain confidentiality of users, the tool utilizes displays where project directors see their project performance levels in relation to the broader group but do not see any individual information that comprise the data set.

A similar report includes the mean and standard deviation for the same category, and the titles of every report will be hyperlinked to either a list or a Google Map of the projects that comprised the aggregate sample. A statistical consultant is paid to review the algorithms underneath the comparisons to ensure the comparisons are meaningful and accurately automated based on career levels, project goals, and other relevant variables.

A similar report includes the iBioSketch Trainee Score, which is a numerical value, similar to a score that would be used in the credit industry to gauge the creditworthiness of a consumer, but computed based on a trainee's career profile and designed to statistically predict the probability of a trainee successfully transitioning to the next career level. Again, a statistical consultant is paid to review the algorithms underneath the scores to ensure that they are strong predictors of trainee's success at the next career level.

A similar report includes the iBioSketch Project Score, which is a numerical value, similar to a score that would be used in the credit industry to gauge the creditworthiness of a consumer, but computed based on a project's progress profile and designed to statistically predict the probability that a project's core design elements will enable its trainees to successfully transition to the next career level. Again, a statistical consultant is paid to review the algorithms underneath the scores to ensure that they are strong predictors of a project's success in trainee's success in helping trainees move to the next level in their career.

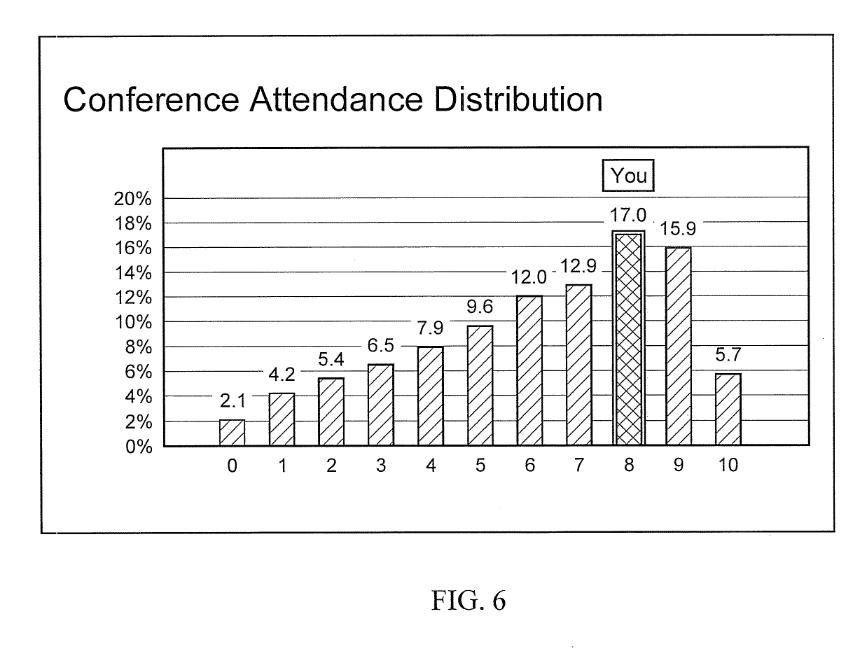

FIG. 6 is a chart illustrating exemplary comparison graphs for trainees for providing web application-based government grant compliance monitoring, data mining, and automatic resume generation according to an embodiment of the subject matter described herein. For example, referring to FIG. 6, conference attendance may be measured and displayed in order for a trainee to see how their performance/history compares with other trainees as a distribution. In the example shown, the trainee viewing the conference attendance distribution has attended eight conferences, 17% of other trainees have also attended eight conferences, 5.7% have attended 10 conferences (the most) while 2.1% have not attended any conferences. In this way a trainee or others viewing the data may quickly determine whether they are ahead or behind the pace for a given performance metric of their fellow trainees.

### User-Level Comparisons

Because trainee compliance and motivation to enter data on a regular basis may be desirable, the subject matter described herein allows trainees to access aggregate comparison data to better gauge their individual success. As with the comparisons for project leaders, no individual data is seen, and when appropriate, three comparisons are made: one to trainees within their funded program, one to trainees (not in their program) but at their career level at their local institution, and one to trainees at their career level in similar programs that use the iBiosketch tracking tool.

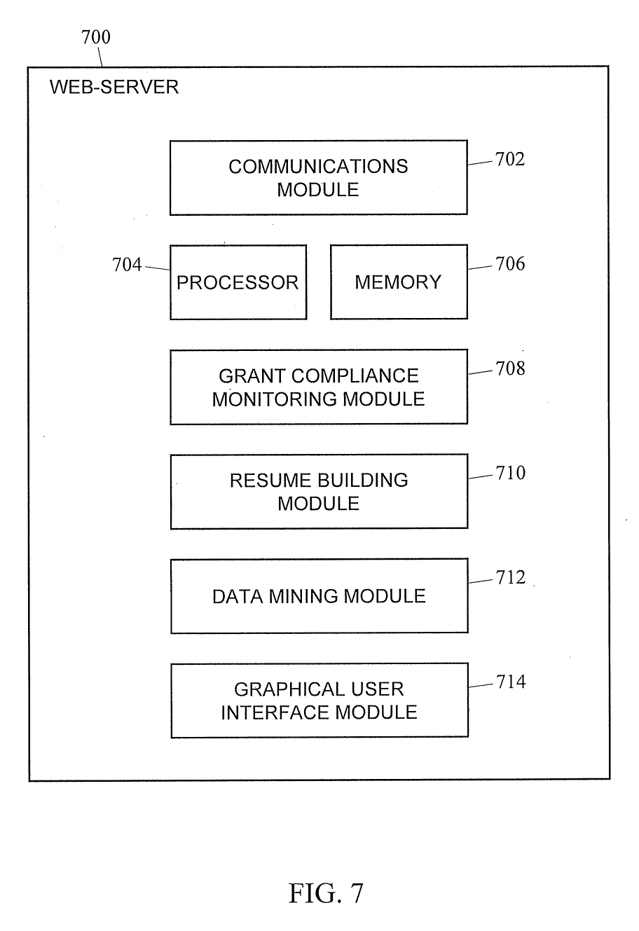

FIG. 7 is a block diagram of an exemplary hardware system for providing web application-based government grant compliance monitoring, data mining, and automatic resume generation according to an embodiment of the subject matter described herein. The functionality described herein may be implemented on a variety of hardware computing platforms, such as web server 700. Web server 700 may include communications module 702 for receiving information from users, such as career progress, published papers, grades, etc. via a web-based interface. Web server 700 may also include processor 704 and memory 706 for storing and executing software instructions. Grant compliance monitoring module 708 may generate a variety of reports for allowing administrators or other third parties to view and/or provide the information provided by users to federal agencies in the format they require as part of their grant compliance and monitoring programs. Resume building module 710 may automatically format the information provided by users into a specified format required by federal agencies. Easing the burden on users in generating up-to-date and properly formatted resumes may provide an incentive for users to upload and update their information. This reduces the cost and increases the accuracy and response rate of users, which is important to successfully monitoring grant compliance. Data mining module 702 may sift through very large amounts of data for useful information. Data mining may use artificial intelligence techniques, neural networks, and advanced statistical tools (such as cluster analysis) to reveal trends, patterns, and relationships, which might otherwise have remained undetected. In contrast to an expert system (which draws inferences from the given data on the basis of a given set of rules) data mining attempts to discover hidden rules underlying the data. Graphical user interface module 714 may provide a graphical interface between one or more modules on the web server and users, administrators, and other third parties. The graphical user interface module may, therefore, operate in conjunction with the other modules of the web server.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for providing grant compliance monitoring and automatic resume generation, the method comprising:
receiving, via a career tracking portion of a web application-based interface, information from a user relating to their career;
automatically formatting and providing at least a subset of the information to a third-party for grant compliance monitoring; and
automatically formatting and providing at least a subset of the information to the user as a resume.

2. The method of claim 1 comprising exporting at least a subset of the information.

3. The method of claim 2 wherein exporting at least a subset of the information includes automatically sharing the information with at least one of a social media website, a web blog, and a wikispace.

4. The method of claim 2 wherein exporting at least a subset of the information includes automatically generating a hyperlink to access at least a subset of the information.

5. The method of claim 4 wherein automatically generating the hyperlink includes dynamically updating the hyperlink based on changes to the information.

6. The method of claim 1 comprising associating a time stamp with the information.

7. The method of claim 1 comprising providing access controls to the information.

8. The method of claim 7 wherein providing access controls includes using at least one of a username, password, personal identification number (PIN), and biometric identification.

9. The method of claim 1 wherein receiving the information includes receiving at least one of demographic and career progress data.

10. The method of claim 1 wherein receiving the information includes receiving information associated with a pre-college, undergraduate, post-baccalaureate, graduate school, postdoctoral fellowship, and career of the user.

11. The method of claim 1 wherein automatically formatting and providing at least a subset of the information to a third-party for grant compliance monitoring includes generating one of a pre-designed report and a customized report.

12. The method of claim 1 comprising providing at least one of a project-level comparison and a user-level comparison.

13. The method of claim 1 comprising sharing the at least a subset of the information between the user and another user.

14. The method of claim 1 comprising automatically providing a reminder to the user to update the information.

15. The method of claim 14 wherein automatically providing a reminder includes providing the reminder via one of email, simple message service (SMS), multimedia message service (MMS), and voice call.

16. The method of claim 1 comprising receiving a request from the third-party that includes receiving a demographic description and, in response, providing information to the third-party that matches the demographic information included in the request for marketing purposes.

17. The method of claim 1 comprising receiving, via a project leader portion of a web application-based interface, information from a project leader, wherein the project leader is different from the user.

18. A web server for providing government grant compliance monitoring, data mining, and automatic resume generation, the system comprising:
a communications module for receiving information from a user relating to their career via a career tracking portion of a web-based application interface;
a grant compliance monitoring module for automatically formatting and providing at least a subset of the information to a third-party for grant compliance monitoring; and
a resume building module for automatically formatting and providing at least a subset of the information to the user as a resume.

19. The web server of claim 18 wherein the communications module is configured to export at least a subset of the information.

20. The web server of claim 19 wherein the communications module is configured to automatically share the information with at least one of a social media website, a weblog, and a wikispace.

21. The web server of claim 19 wherein the communications module is configured to automatically generate a hyperlink to access at least a subset of the information.

22. The web server of claim 21 wherein the communications module is configured to dynamically update the hyperlink based on changes to the information.

23. The web server of claim 18 wherein the communications module is configured to associate a time stamp with the information.

24. The web server of claim 18 wherein the communications module is configured to provide access controls to the information.

25. The web server of claim 24 wherein the communications module is configured to use at least one of a username, password, personal identification number (PIN), and biometric identification.

26. The web server of claim 18 wherein the communications module is configured to receive at least one of demographic and career progress data.

27. The web server of claim 18 wherein the communications module is configured to receive information associated with a pre-college, undergraduate, post-baccalaureate, graduate school, postdoctoral fellowship, and career of the user.

28. The web server of claim 18 wherein the resume building module is configured to generate one of a pre-designed report and a customized report.

29. The web server of claim 18 comprising a data mining module is configured to provide at least one of a project-level comparison and a user-level comparison.

30. The web server of claim 18 wherein the communications module is configured to share the at least a subset of the information between the user and another user.

31. The web server of claim 18 wherein the communications module is configured to automatically provide a reminder to the user to update the information.

32. The web server of claim 31 wherein the communications module is configured to provide the reminder via one of email, simple message service (SMS), multimedia message service (MMS), and voice call.

33. The web server of claim 18 wherein the communications module is configured to receive a demographic description and, in response, providing information to the third-party that matches the demographic information included in the request for marketing purposes.

34. The web server of claim 18 comprising a project leader portion of a web application-based interface for receiving information from a project leader, wherein the project leader is different from the user.

35. A non-transitory computer readable medium comprising computer executable instructions that when executed by a processor of a computer control the computer to perform steps comprising:
receiving information from a user relating to their career via a web-based application interface;
automatically formatting and providing at least a subset of the information to a third-party for grant compliance monitoring; and
automatically formatting and providing at least a subset of the information to the user as a resume.
